(19) United States
(12) Patent Application Publication
(10) Pub. No.: US 2013/0273466 A1
(43) Pub. Date: Oct. 17, 2013

(54) TONER HAVING EXCELLENT ENVIRONMENTAL RESISTANCE, FLUDITY, AND CHARGEABILITY

(71) Applicants: Dae Woong Choi, Daejeon (KR); Jae Bum Park, Daejeon (KR); Dong Woo Kim, Daejeon (KR); Young Jae Kwon, Daejeon (KR)

(72) Inventors: Dae Woong Choi, Daejeon (KR); Jae Bum Park, Daejeon (KR); Dong Woo Kim, Daejeon (KR); Young Jae Kwon, Daejeon (KR)

(73) Assignee: SAMSUNG FINE CHEMICALS CO., LTD., Ulsan (KR)

(21) Appl. No.: 13/996,857

(22) PCT Filed: Dec. 21, 2011
(86) PCT No.: PCT/KR11/09944

§ 371 Date: Jun. 21, 2013

(30) Foreign Application Priority Data
Dec. 24, 2010 (KR) 10-2010-0134750

(51) Int. Cl. G03G 9/00; G03G 15/08

(52) U.S. Cl. CPC G03G 9/0827
USPC 430/105; 430/110.3; 399/252

(57) ABSTRACT

Provided is a toner particle having excellent environmental resistance, fluidity, and chargeability for developing an electrostatic image. The toner particle comprises a coupling resin, a release agent, and a coloring agent, and satisfies Formula (1) below:

8.5≦SMF≦10.5 (1),
wherein the surface morphology factor (SMF) of the formula can be represented by following Formula (2):

SMF=−log(4/3×π×D³×RD×B×C) [m²/ea] (2).

### TECHNICAL FIELD

The present invention relates to toner particles for developing an electrostatic image, a developer for forming an electrophotographic image including the same, and a method of forming an electrophotographic image using the toner particles, and more particularly, to toner particles having excellent environmental resistance, fluidity, and chargeability, a developer for forming an electrophotographic image including the same, and a method of forming an electrophotographic image using the toner particles.

### BACKGROUND ART

A variety of electrophotographic printing systems have been reported. By using an electrophotographic printing system, an electrostatic latent image is formed on a photosensitive member using a photoconductive material via various methods, the electrostatic latent image is developed by supplying toner thereto to form a visual toner image, the toner image is transferred onto a transfer image-receiving medium such as paper, and the toner image is fixed on the medium by applying heat and/or pressure thereto.

An image-forming apparatus using an electrophotographic printing system is available in various devices such as printers, copiers, facsimiles, and the like. The image-forming apparatus requires a method of developing an image having better resolution and sharpness compared to other apparatuses, and an appropriate toner is being developed in this regard.

In particular, there is a need for a toner that has a constant image density, regardless of a usage environment thereof. Also, a toner having excellent fluidity and ability to prevent a low quality image that is caused by the scattering of the toner particles is needed as well as a toner having excellent chargeability and environmental resistance.

A polymerized toner generally has excellent circularity compared to a pulverized toner. However, when toner particles are perfectly spherical and particle surfaces are too smooth, there are problems in that chargeability of the toner particles are decreased, external additives are isolated and aggregated to each other rather than being embedded in toner particles, and the like. A mass of the aggregated external additives may not only damage components included in an image-forming apparatus, such as an organic photoconductive drum, a developing roller, a charge roller, and a fusing unit, but also degrade image quality.

Surface characteristics of toner particles are closely associated with a specific surface area thereof, which is based on a Brunauer-Emmett-Teller (BET) theory. For example, when toner particles are not perfectly spherical, a specific surface area thereof is large. When the specific surface area based on the BET theory is too large, the above-mentioned problems may be solved, but the toner particles are then strongly hygroscopic. Accordingly, changes in triboelectrostatic characteristics depending on environmental conditions are also so great that changes in the image quality depending on usage environment of toner are also great.

### DETAILED DESCRIPTION OF THE INVENTION

### Technical Problem

An embodiment of the present invention provides toner particles having excellent environmental resistance, fluidity, and chargeability.

An embodiment of the present invention also provides an electrostatic image developer including the toner particles.

An embodiment of the present invention also provides a method of forming an electrophotographic image using toner particles.

### Technical Solution

According to an aspect of the present invention, there are provided toner particles for developing an electrostatic image including a binder resin, a releasing agent, and a colorant, and the toner particles satisfy Formula (1) below:

8.5≦SMF≦10.5 (1)

wherein, a surface morphology factor (SMF) is obtained by Formula (2) below:

SMF=−log(4/3×π×D³×RD×B×C) [m²/ea] (2)

wherein, D represents an average radius (μm) of the toner particles,

RD represents a net density (g/cm³) of the toner particles,

B represents a specific surface area (m²/g) based on Brunauer-Emmett-Teller (BET) theory, and

C represents circularity.

In some embodiments, the toner particles may have an average radius in a range from about 2.35 to about 5.75 μm.

In some other embodiments, the toner particles may have a net density in a range from about 1.021 to about 1.316 g/cm³.

In some other embodiments, the toner particles may have a specific surface area based on the BET theory in a range from about 0.591 to about 3.129 m²/g.

In some other embodiments, the toner particles may have circularity in a range from about 0.962 to about 0.975.

In some other embodiments, the toner particles may have cohesiveness in a range from about 6.50% to about 15.1%.

According to another aspect of the present invention, there is provided an electrostatic image developer, including the toner particles.

According to another aspect of the present invention, there is provided a method of forming an electrophotographic image, the method including forming a toner image by adhering toner to a photoreceptor surface on which an electrostatic latent image is formed, and transferring the toner image onto a transfer medium.

Hereinafter, toner particles according to exemplary embodiments of the present invention will be described in detail.

Toner particles for developing an electrostatic image according to an embodiment of the present invention each include a binder resin, a releasing agent, and a colorant, and the toner particles satisfy Formula (1) below:

8.5≦SMF≦10.5 (1)

wherein, a surface morphology factor (SMF) is obtained by using Formula (2) below:

SMF=−log(4/3×π×D³×RD×B×C) [m²/ea] (2)

wherein, D represents an average radius (μm) of the toner particles,

RD represents a net density (g/cm³) of the toner particles,

B represents a specific surface area (m²/g) based on Brunauer-Emmett-Teller (BET) theory, and

C represents circularity.

Regarding a unit of the SMF in m²/ea, ‘ea’ refers to the number of units of the toner particles. When D and RD in Formula (2) above are each substituted with a specific value, the measured values of D and RD must be converted so as to have a unit of the SMF in m²/ea.

In order to control surface characteristics of toner particles, toner particles having a specific surface area based on the BET theory in a certain range were conventionally used. However, the specific surface area itself was not enough to closely control the surface characteristics of the toner particles. For example, even though the specific surface area based on the BET theory is within the certain range, problems with decreasing transfer efficiency still exist if a circularity value is too small.

According to an embodiment of the present invention, a correlation among an average radius, a net density, and circularity of toner particles in addition to the specific surface area based on the BET theory is regulated, and accordingly, the SMF value corresponding to an average value of the surface area per toner particle may have a value within a certain range. Therefore, the toner particles may improve all fluidity, environmental resistance, and chargeability.

The SMF value is equal to or more than 8.5 m²/ea and equal to or less than 10.5 m²/ea, and in some embodiments, the SMF value is equal to or more than 9.4 m²/ea and equal to or less than 9.6 m²/ea. When the SMF value is less than 8.5 m²/ea, the toner may have a high specific surface area value and excellent fluidity, but its environmental differences are large. Meanwhile, when the SMF value is more than 10.5 m²/ea, the toner may have a low specific surface area value, poor fluidity, and its environmental differences are large. In some embodiments, the toner particles may have cohesiveness in a range from about 6.50% to about 15.1%.

In Formula (2) above, a net density of the toner particles may be measured by using a net density apparatus such as a pycnometer. For example, by using an AccuPyc II 1340 pycnometer (manufactured by Micromeritics Co., U.S.A) in a gas measurement method, a net density is measured five times for each sample, and then an average value thereof is obtained.

In some embodiments, the net density of the toner particles may be in a range from about 1.021 to about 1.316 g/cm³. When the net density of the toner particles is within the above ranges, the SMF value in an appropriate region of the ranges may be obtained.

In some embodiments, the average radius of the toner particles may be in a range from about 2.35 to about 5.75 μm. When the average radius of the toner particles is within the above ranges, the SMF value in an appropriate region of the ranges may be obtained. The average radius used herein refers to a half value of a volume average particle size of the toner particles.

In some embodiments, the specific surface area based on the BET theory of the toner particles may be in a range from about 0.591 to about 3.129 m²/g. When the specific surface area of the toner particles is within the above ranges, the SMF value in an appropriate region of the ranges may be obtained.

In some embodiments, the circularity of the toner particles may be in a range from about 0.962 to about 0.975. When the circularity of the toner particles is within the above ranges, the SMF value in an appropriate region of the ranges may be obtained.

The specific surface area based on the BET theory of the toner particles may be generally controlled by changing drying conditions of an air-flow type dryer during the manufacture of the toner particles.

Also, the circularity of the toner particles may be controlled by changing fusing conditions or the like during the manufacture of the toner particles.

The SMF value of the toner particles may be controlled to be a value within the above ranges by changing dry conditions, aggregation conditions, fusing conditions, or the like.

The toner particles may be manufactured by a method including: mixing a polyester resin dispersion, a wax dispersion, and a colorant dispersion together to prepare a mixture, and then homogenizing the mixture by adding an agglomerating agent to the mixture, aggregating the homogenized mixture, and fusing the aggregated toner particles.

A polyester resin and an organic solvent are added to a polar solvent including a surfactant and a dispersion stabilizer while stirring to obtain a mixture. Then, the mixture is heated to prepare a polyester resin dispersion having less than 10,000 ppm of the residual organic solvent.

By manufacturing the polyester resin dispersion in a single reactor, the preparation may be simplified and the time required for the preparation may be shortened. In addition, the dispersion is homogeneously neutralized by the dispersion stabilizer, and thus particle size of the dispersion may be uniform.

Also, the organic solvent may be easily removed by sequentially adding the polyester resin in the above-mentioned order during the dispersion preparation whereas in a conventional way, the polyester resin is completely dissolved in the organic solvent and the rest of the components is mixed thereto to prepare the polyester resin dispersion.

The polar solvent including the surfactant and dispersion stabilizer may be prepared by sequentially adding the surfactant and dispersion stabilizer or simultaneously adding the same.

In some embodiments, the surfactant, the dispersion stabilizer, the polyester resin, and the organic solvent are sequentially added to the polar solvent.

During the polyester resin dispersion preparation, a heat treatment may be performed at a temperature above a boiling point of the organic solvent. The heat treatment may be performed for about 3 to about 15 hours.

The particle size of the polyester resin dispersion may be in a range from about 50 to about 300 nm.

Examples of the polar solvent are distilled water, methanol, ethanol, butanol, acetonitrile, acetone, and ethyl acetate. For example, the polar solvent may be distilled water. An amount of the polar solvent may be in a range from about 150 to about 500 parts by weight based on 100 parts by weight of the polyester resin.

A weight-average molecular weight of the polyester resin may be in a range from about 5,000 to about 50,000. When the weight-average molecular weight of the polyester resin is less than 5,000, preservability and fixability of the toner particles may be adversely affected. Also, when the weight-average molecular weight of the polyester resin is more than 50,000, the toner particles may have an appropriate preservability while its fixability may be adversely affected.

In addition, a polydispersity index (PDI) of the polyester resin may be in a range from about 2 to about 10, and a peak molecular weight (Mp) measured by a gel-permeation chromatography (GPC) may be in a range from about 1,000 to about 10,000. The Mp measured by the GPC herein refers to a molecular weight that is obtained by a calculation based on a peak point of an elution curve measured by the GPC. The GPC measurement conditions are as follows:

Apparatus: HLC8020, Toyo Soda Manufacturing Co., Ltd

Column: TSKgelGMHXL connected in 3 rows in series (column size: 7.8 mm (ID)×30.0 cm(L)) connected in series, Toyo Soda Manufacturing Co., Ltd

Oven temperature: 40° C.

Eluent: Tetrahydrofuran (THF)

Based on holding time corresponding to the peak point of the elution curve, a calibration curve is drawn using standard polystyrene, and the Mp is obtained.

Examples of the standard polystyrene sample used for drawing the calibration curve are TSK standard (Toyo Soda Manufacturing Co., Ltd), A-500 (molecular weight (Mw) 5.0×10²), A-2500 (Mw 2.74×10³), F-2 (Mw 1.96×10⁴), F-20 (Mw 1.9×10⁵), F-40 (Mw 3.55×10⁵), F-80 (Mw 7.06×10⁵), F-128 (Mw 1.09×10⁶), F-288 (Mw 2.89×10⁶), F-700 (Mw 6.77×10⁶), and F-2000 (Mw 2.0×10⁷).

The peak point of the elution curve used herein refers to a maximum point of the elution curve. If there are more than 2 maximum points, the peak point is the point where the elution curve is granted as a maximum. Regarding the eluent, examples thereof are not specifically limited, and a solvent such as chloroform that dissolves a polyester resin may be used as the eluent in addition to THF.

A glass transition temperature of the polyester resin is in a range from about 40 to about 80° C., for example, in a range from about 50 to about 75° C. When the glass transition temperature is lower than 40° C., toner formed using the polyester resin particles may have problems in terms of preservation stability. Meanwhile, when the glass transition temperature is higher than 80° C., offset is likely to occur, which can be serious particularly during color printing.

The polyester resin may not include a sulfonic acid.

The polyester resin may be prepared by polycondensation of an acid component and an alcohol component, wherein the acid component may be polyvalent carboxylic acid, and the alcohol component may be polyhydric alcohols.

Examples of the polyhydric alcohols are polyoxyethylene-(2,0)-2,2-bis(4-hydroxyphenyl)propane, polyoxypropylene-(2,0)-2,2-bis(4-hydroxyphenyl)propane, polyoxypropylene-(2,2)-polyoxyethylene-(2,0)-2,2-bis(4-hydroxyphenyl)propane, polyoxyethylene-(2,3)-2,2-bis(4-hydroxyphenyl)propane, polyoxypropylene-(6)-2,2-bis(4-hydroxyphenyl)propane, polyoxypropylene-(2,3)-2,2-bis(4-hydroxyphenyl)propane, polyoxypropylene-(2,4)-2,2-bis(4-hydroxyphenyl)propane, polyoxypropylene-(3,3)-2,2-bis(4-hydroxyphenyl)propane, polyoxyethylene-(6)-2,2-bis(4-hydroxyphenyl)propane, ethylene glycol, 1,3-propylene glycol, 1,2-propylene glycol, 1,4-butylene glycol, 1,3-butylene glycol, glycerol, and polyoxypropylene. Examples of the polyvalent carboxylic acid are aromatic polyvalent acid and/or alkyl ester thereof that is conventionally used in the preparation of the polyester resin. Examples of the aromatic polyvalent acid are terephthalic acid, isophtalic acid, trimellitic acid, pyromellitic acid, 1,2,4-cyclohexanetricarboxylic acid, 2,5,7-naphthalene tricarboxylic acid, 1,2,4-naphthalene tricarboxylic acid, 1,2,5-hexane tricarboxylic acid, 1,2,7,8-octane tetracarboxylic acid, alkyl ester thereof, or the like, wherein examples of the alkyl group are a methyl group, an ethyl group, a propyl group, a butyl group, or the like. The aromatic polyvalent acid and alkyl ester thereof may be used singly or in the form of two or more kinds in combination.

An acid value of the polyester resin may be in a range from about 5 to about 50, for example, in a range from about 10 to about 20.

The organic solvent used in the polyester resin dispersion may be at least one selected from the group consisting of methyl acetate, ethyl acetate, isopropyl acetate, methyl ethylketone, dimethyl ether, diethyl ether, 1,1-dichloroethane, 1,2-dichloroethane, dichloromethane, and chloroform, but is not limited thereto. An amount of the organic solvent may be in a range from about 150 to about 500 parts by weight based on 100 parts by weight of the polyester resin.

A surfactant used in the polyester resin dispersion may be an anionic surfactant. An amount of the surfactant may be in a range from about 1 to about 4 parts by weight based on 100 parts by weight of the polyester resin.

A dispersion stabilizer used in the polyester resin dispersion may be a monovalent cation-containing base, and for example, at least one selected from the group consisting of potassium hydroxide, sodium hydroxide, sodium carbonate, sodium bicarbonate, lithium hydroxide, potassium carbonate, ammonia, triethylamine, triethanolamine, pyridine, ammonium hydroxide, diphenylamine and a derivative thereof, and polyethyleneamine and a derivative thereof, and for example, sodium hydroxide or potassium hydroxide.

An amount of the dispersion stabilizer used herein is associated with the acid value of the polyester resin. As the acid value of the polyester resin gets higher, the amount of the dispersion stabilizer is also increased so that a dispersion having narrow particle size distribution may be prepared. The dispersion stabilizer may be used in about 2 to about 3 equivalents based on the acid value of the polyester resin.

A colorant dispersion may be prepared by dispersing a colorant in water using a surfactant dispersing agent, or the like. When the colorant is dispersed in water, the dispersing agent used herein may be an anionic surfactant or a nonionic surfactant, and in some embodiments, the anionic surfactant may be used. By using a dispersing agent, a pigment may be easily dispersed in water and the dispersed particle size of the pigment in toner may be smaller so that toner with excellent properties may be prepared. Through a subsequent washing process, unnecessary dispersing agents may be removed.

The colorant may be appropriately selected from among a black pigment, a cyan pigment, a magenta pigment, a yellow pigment, and a combination thereof, and the pigment being commercially used in general.

An amount of the colorant, which needs to be sufficient enough to form a visual toner image formed by toner coloring, may be in a range from about 3 to 15 parts by weight based on 100 parts by weight of the polyester resin. When the amount of the colorant is less than 3 parts by weight, a coloring effect of the toner may be insufficient, and when the amount of the colorant is more than 15 parts by weight, electrical resistance of the toner becomes low. Due to the low electrical resistance, an electrification quantity may not be sufficiently obtained, and the toner may cause pollution.

A wax dispersion may be prepared by adding and dispersing wax and silica in a dispersion medium.

The dispersion medium may include at least one of water and a water-soluble organic solvent. In regard to the water, purified water may be used. The water-soluble organic solvent may have a dielectric constant of 5 or more, for example, 10 or more. When the dielectric constant of the water-soluble organic solvent is less than 5, the dielectric constant of the wax dispersion also becomes smaller, which may diminish an electrostatic repulsive-force among wax particles and degrade dispersion stability. Examples of the water-soluble organic solvent satisfying the above dielectric constant are ether-, alcohol-, ether alcohol-, ester-, ketone-, acid-, amines, acid amines, or the like. More particularly, the water-soluble organic solvent may be diethylene glycol monobutyl ether, triethylene glycol monobutyl ether, propylene glycol monobutyl ether, ethylene glycol, diethylene glycol, propylene glycol, dimethyl sulfoxide, ethylene carbonate, propylene carbonate, or the like.

Wax included in the wax dispersion may be at least one of paraffinic-based wax and polyester-based wax. The paraffinic-based wax may have straight-chain saturated hydrocarbons as a main body having 20 to 36 carbon atoms, and thus its weight-average molecular weight is in a range from about 30 to about 500, and a melting point thereof is in a range from about 40 to about 80° C. When the paraffinic-based wax is provided in the toner, the toner shows excellent release properties. However, due to large penetration, a surface of a fixing roller may be contaminated. Here, the term ‘penetration’ as used herein refers to an indicator of consistency or hardness of materials. In order to solve the above-mentioned problems, a polyester wax, which is a type of a synthetic wax, may be added to the toner.

A mixture of the paraffinic wax and the polyester wax, for example, HNP-9 and HNP-11, may be used.

A usage amount of the wax may be in a range from about 10 to about 40% by weight, for example, in a range from about 25 to about 35% by weight. When the usage amount of the wax is within the above ranges, the wax may have excellent dispersion stability and may sufficiently act as a releasing agent.

The wax dispersion may further include a surfactant. The surfactant may be at least one selected from the group consisting of a non-ionic surfactant, an anionic surfactant, a cationic surfactant, and an amphoteric surfactant.

Examples of the non-ionic surfactant are polyvinyl alcohol, polyacrylic acid, polyoxyethylene cetyl ether, polyoxyethylene lauryl ether, polyoxyethylene octyl phenyl ether, polyoxyethylene stearyl ether, polyoxyethylene norylphenyl ether, ethoxylate, phosphate norylphenol, triton, dialkyl phenoxypoly(ethyleneoxy)ethanol, or the like. Examples of the anionic surfactant are sodium-dodecyl sulfate, sodium-dodecylbenzene sulfonate, sodium-dodecylnaphthalene sulfate, dialkyl benzenealkyl sulfate, sulfonate salt, or the like. Examples of the cationic surfactant are alkylbenzene dimethyl ammonium chloride, alkyl trimethyl ammonium chloride, distearyl ammonium chloride, or the like. Also, examples of the amphoteric surfactant are amino acid-typed amphoteric surfactant, betaine-based amphoteric surfactant, lecithin, taurine, or the like. Aforementioned surfactants may be used singly or in the form of two or more kinds in combination.

The wax dispersion may include silica in a range from about 0.5 to about 2% by weight.

When the silica is within the above ranges, the toner may have a deodorizing effect without affecting the toner properties such as a charge quantity or a charge speed.

The silica is not particularly limited as long as it has a deodorizing effect. In general, the silica may have an average particle size in a range from about 5 to about 50 nm.

The silica that is commercially available may be used, for example, RY300 manufactured by Aerosil Co., Ltd.

The dispersion may be performed when the reactant is heated up to a point that is higher than the melting point of the wax.

Here, a dispersing device used for the dispersion may be a high-speed tumbling mill, a classifier embedded high-speed tumbling mill, a ball mill, a medium agitating mill, a consolidated shear mill, a colloid mill, a roll mill, or the like. Also, the milling media may be, depending on the material, a strong bead made of stainless steel or steel, or a ceramics beads made of alumina, enstatite, zirconium oxide, zircon, silica, silicon carbide, and silicon nitride. In addition, a wax dispersion of nano-sized particles may be obtained by using an Ultimaizer system (manufactured by Amstec., Model HJP-25030).

After mixing each dispersion prepared according to the dispersion preparation together, an agglomerating agent and an acid are added while stirring to homogenize the dispersion and then aggregate toner particles.

The aggregation may be performed at room temperature, but in some embodiments, it may be heated close to a glass transition temperature (Tg) of the polyester resin. Stirring the dispersion mixture using by mechanical shearing force through use of stirrer may form the aggregated particles with uniform particle size and shape.

Any known agglomerating agent may be used, and for example, an organic material containing ions having polarity opposite to that of an electrolyte or a pigment may be used. Also, the agglomerating agent may be sodium chloride (NaCl) that is easy to wash out with pure water and has high solubility in water. An amount of the agglomerating agent may be in a range from about 0.3 to about 6% by weight based on the total solid contents, for example in a range from about 1.0 to about 5% by weight. When the amount of the agglomerating agent is less than 0.3% by weight, the aggregation may not be easily performed, and when the amount of the agglomerating agent is more than 6% by weight, the size of the aggregated particles may be too large.

The agglomerating agent is used in an amount of about 0.3 to about 6% by weight based on the total solid contents of the material that is added during the aggregation. However, the dispersion stabilizer used for the polyester resin dispersion preparation performs an auxiliary role during the aggregation. Thus, the dispersion stabilizers may be added in the aggregation process.

The pH may be controlled by adding acids during the aggregation process, for example, in a range from about 4.5 to about 6.5.

The aggregation may be performed by stirring the reaction solution at a temperature of about 40 to about 60° C. and at a speed of about 1.0 to about 7.0 m/sec.

For freezing, the temperature of the reaction solution is maintained within the above ranges and its pH is increased to 10.

Here, in order to increase the pH, an inorganic base such as NaOH, KOH, and LiOH is added to the reaction solution.

Next, the mixed solution containing toner particles is heated to uniformize the particle size and shape of the aggregated toner particles. The mixed solution may be heated above the Tg of the polyester resin to have a particle size in a range from about 1 to about 20 μm. Accordingly, toner particles may be formed in a uniform particle size and shape.

When the mixed solution is heated at the Tg of the polyester resin or higher, the surface property of the toner particles may be improved. However, when a polyester resin dispersion or a polystyrene butyl acrylate latex is added to the mixed solution to surround the toner particles prepared according to the aggregation process before the heating to a temperature above the Tg of the polyester resin, the pigment or wax included inside of the dispersion may be prevented from leaking, thereby hardening the toner. Here, an example of the polyester resin dispersion or the polystyrene butyl acrylate latex that are additionally added to the mixed solution is a resin dispersion having the same properties (i.e., in terms of Tg and molecular weight) as those of the polyester resin dispersion used in the previous step, or having a higher Tg and molecular weight. When the polyester resin dispersion having a higher Tg and molecular weight is used, the Tg thereof may be in a range from about 60 to about 85° C., and the molecular weight thereof may be in a range from about 10,000 to about 300,000. Due to the resin dispersion that is additionally added to the mixed solution, the particle size may become larger while surrounding the toner particles prepared according to the aggregation process. In order to prevent such a phenomenon, a surfactant may be further added or a pH thereof may be controlled, and the temperature may be also increased up to the point above the Tg of the polyester resin to perform a fusing process.

Then, toner particles obtained by the fusing are washed with water and dried. Here, the mixed solution including the toner particles is cooled down to room temperature and filtered, the filtrate is removed, and the toner is washed with water. During the washing, pure water having conductivity of 10 μS/cm or less may be used, and the toner is washed until the filtrate obtained by washing the toner has conductivity of 50 μS/cm or less. The washing of the toner with pure water may be performed in batch-type or in continuous-type method. The washing of the toner using pure water is performed in order to remove unnecessary ingredients other than toner components, such as impurities that can affect chargeability of the toner, and unnecessary agglomerating agents that are not involved in the aggregation.

When an inorganic salt of a monovalent metal is used as an agglomerating agent, toner particles are not likely to be re-aggregated due to reactivation of the inorganic salt according to pH change during a washing process, and the inorganic salt of the monovalent metal has much greater solubility in water than an inorganic salt of a multivalent metal. Thus, the inorganic salt of the monovalent metal is easily removed during a washing process, and its remaining amount inside the toner is significantly low, and accordingly, melt viscosity of the toner particles may not be increased and toner particles having better fixing properties may be obtained.

Then, the toner obtained after the washing process is dried using a fluidized bed dryer, a flash jet dryer, or the like. Also, a desired external additive may be added in the toner obtained by the drying process.

According to another aspect of the present invention, provided is a developer for forming an electrostatic image, including the toner particles. The developer may further include at least one carrier selected from the group consisting of ferrite coated with an insulating material, magnetite coated with an insulating material, and iron powder coated with an insulating material. For example, the developer may be the ferrite or magnetite each coated with insulating materials.

According to another aspect of the present invention, provided is a method of forming an electrophotographic image using the toner particles.

More particularly, an imaging method includes forming a toner image by adhering the toner or the electrostatic image developer to the surface of a photoreceptor on which an electrostatic latent image is formed, and transferring the toner image to a transfer medium.

The toner or the electrostatic image developer, according to embodiments of the present invention, is used in an electrophotographic image-forming apparatus, wherein the image-forming apparatus using an electrophotographic process refers to a laser printer, a copier, a facsimile, or the like.

### Advantageous Effects

The toner particles according to the present invention have excellent environmental resistance, fluidity, and chargeability, and show a constant image quality regardless of the usage environment.

### BEST MODE FOR CARRYING OUT THE INVENTION

Hereinafter, one or more embodiments will be described in detail with reference to the following examples. However, these examples are not intended to limit the purpose and scope of the invention.

Average Particle Diameter

An average particle diameter of a toner was measured by using a Multisizer 3 Coulter Counter. An aperture of 100 μm was used in the Multisizer 3 Coulter Counter, an appropriate amount of a surfactant was added to 50 to 100 ml of ISOTON-II (Beckman Coulter Inc.) as an electrolyte, and 10 to 15 mg of a sample to be measured was added thereto, and the resultant was dispersed in a ultrasonic dispersing apparatus for 5 minutes to prepare a sample. After about 30,000 particles were measured, the average particle size was recorded.

Circularity

Circularity of toner was measured using a FPIA-3000 (SYSMEX Inc.). A sample was pretreated as follows: a 20 ml of a vial was filled with 15 ml of distilled water, and then 5 to 10 mg of a toner sample that had been externally added was added to the vial. Next, 3 to 5 drops of a neutral surfactant was loaded to the vial, and particles included in the toner sample were dispersed by ultrasonography in a sonicator for 30 minutes. 7 to 10 ml of the pretreated sample was measured after adding it in a sample inlet of the FPIA-3000. Then, the number of tone particles was 3,000, and the average circularity thereof was recorded.

Net Density

2.7372 g of a sample was added and a net density thereof was measured by using a gas pycnometer Accupyc II 1340 (Micromeritics Inc.) that uses an inert gas (i.e., helium gas). The temperature of the measured sample was maintained at 28.6° C., and the average net density was recorded after measuring 5 times in total.

Specific Surface Area Based on Brunauer-Emmett-Teller (BET) Theory

1.4 g of a sample was added to a sample tube, and the sample tube was pretreated at a temperature of 40° C. for 4 hours. Thereafter, a specific surface area of the sample was measured by using an ASAP 2020 (Micromeritics Inc., U.S.A). The measurement was conducted until the value reached four decimal points, and the average specific surface area was recorded after being measured 3 times in total.

### Preparation Example 1

### Preparation of Polyester Resin

A 3 L reactor equipped with a stirrer, a nitrogen gas inlet, a thermometer, and a cooler was provided in an oil bath, heating medium. 45 g of terephthalic acid, 39 g of isophtalic acid, 75 g of 1,2-propyleneglycol, and 3 g of trimellitic acid were added to the reactor, and 500 ppm of dibutyl-tin-oxide, based on total weight of the monomer, was added to the reactor as a catalyst. While stirring the reactor at 150 rpm, the temperature of the reactor was increased to 150° C. After the reaction occurred for 6 hours and the reactor was heated to a temperature of 220° C., the reactor was depressurized to 0.1 torr for removal of byproducts and the reaction proceeded for 15 hours under the same pressure conditions to then obtain a polyester resin.

Glass Transition Temperature (Tg, ° C.)

A glass transition temperature Tg of a sample was measured by using a differential scanning calorimeter DSC (manufactured by Netzsch Co.) by heating the sample at a temperature of 20 to 200° C. at a heating rate of 10° C./min, rapidly cooling the sample to 10° C. at a cooling rate of 20° C./min, and heating the sample again at a heating rate of 10° C./min.

Acid Value

The resin was dissolved in dichloromethane and cooled, and an acid value (mg KOH/g) was then measured by titrating with a 0.1 N KOH methyl alcohol solution.

Weight-Average Molecular Weight and Peak Molecular Weight (Mp)

A weight-average molecular weight of a binder resin was measured by using a gel permeation chromatography (GPC) method, which uses a calibration curve using a reference sample (i.e., polystyrene).

Based on a holding time corresponding to a peak point of the obtained elution curve, a peak molecular weight (Mp) was obtained by conversion of the reference polystyrene according to the GPC method. The peak point of the elution curve refers to a maximum value of the elution curve. If there are at least 2 peak points, the peak point is the point where the elution curve reaches the maximum value. Also, a signal intensity I(Mp) of the GPC curve with regard to the location of the peak molecular weight and another signal intensity I(M100000) of the GPC curve with regard to the location of the molecular weight of 100,000 each refer to a difference in signal intensity between the signal strength and a baseline with regard to the location of the peak molecular weight and another difference in signal intensity between the signal strength and the baseline with regard to the location of the molecular weight of 100,000, which are represented by a potential mV:

Apparatus: HLC8020 manufactured by Toyo Soda Manufacturing Co., Ltd.

Column: TSKgelGMHXL (column size: 7.8 mm(ID)×30.0 cm(L)) connected in 3 rows in series by Toyo Soda Manufacturing Co., Ltd.

Oven temperature: 40° C.

Eluent: THF

Sample concentration: 4 mg/10 Me

Filtration condition: filteration of a sample solution by using 0.45 μm Teflon (registered trademark) membrane filter

Velocity of flow: 1 Ml/min

Dosage: 0.1 Ml

Detector: RI

Reference polystyrene sample for drawing a calibration curve: TSK standard manufactured by Toyo Soda Manufacturing Co., Ltd., A-500(molecular weight 5.0×10²), A-2500(molecular weight 2.74×10³), F-2(molecular weight 1.96×10⁴), F-20(molecular weight 1.9×10⁵), F-40(molecular weight 3.55×10⁵), F-80(molecular weight 7.06×10⁵), F-128(molecular weight 1.09×10⁶), F-288(molecular weight 2.89×10⁶), F-700(molecular weight 6.77×10⁶), and F-2000(molecular weight 2.0×10⁷).

The glass transition temperature Tg of the obtained polyester resin is 66° C., the acid value thereof is 11 mgKOH/g, the weight-average molecular weight thereof is 18,000, Mp thereof is 5100, and T₁₁₂ thereof is 125° C.

### Preparation Example 2

### Preparation of Polyester Resin Dispersion

46 g (that is, 2.5 equivalents based on the acid value of the polyester resin) of a 4% by weight sodium hydroxide solution, which is a dispersion stabilizer, 6.67 g of a surfactant (Dowfax, Dowcorning Co., 1% by weight compared to the polyester resin amount), and 958 g of water were added to a 3 L reactor equipped with a thermometer and an impeller-type stirrer of the polyester resin. Here, 300 g of the polyester resin was added thereto in a solid state and 500 g of methyl ethylketone was also added thereto. After the reactor was refluxed at a temperature of 70° C. for 1 hour, the organic solvent was removed by purging nitrogen at a temperature of 80° C. for 4 hours, and finally the polyester resin dispersion was obtained.

### Preparation Example 3

### Preparation of Cyan Pigment Dispersion

3 kg of a cyan pigment (ECB 303, Dainichiseika Color & Chemicals Mfg. Co., Ltd.) was introduced into a 20 L reactor, 11.5 kg of purified water, and 0.6 kg of hydroxypropylmethyl cellulose acetate phthalate (AnyCoat-P, Samsung Fine Chemicals Co., Ltd) were further added to the reactor, and stirring was performed at a speed of 50 rpm. Next, contents in the reactor were transferred to a ball mill type reactor to perform a pre-dispersion. As a result of the pre-dispersion, dispersed cyan pigment particles having a volume-average particle diameter (D50(v)) of 3.4 μm (measured by using a Coulter Multisizer by Beckman Coulter, Inc.) were obtained. Then, an actual dispersion was performed on contents in the reactor at a pressure of 1,500 bar by using a Ultimaizer system (Amstec Ltd., Model HJP25030). As a result of the actual dispersion, cyan pigments dispersed in nano-sizes were obtained, D50(v) measured by using a Microtrac 252 (Microtrac Inc.) was 150 nm.

### Preparation Example 4

### Preparation of Wax Dispersion

65 g of an anionic surfactant (i.e., alkyldiphenyloxide disulfonate, 45% Dowfax 2A1), 1,935 g of distilled water, 1,000 g of wax (NOF Corporation, Japan, WE-5), and silica having an average particle size of 7 nm (0.5% by weight based on a solid content of a toner) were added to a 5 L reactor equipped with a stirrer, a thermometer, and a condenser. Then, the mixture was dispersed using a homogenizer (IKA Co.) for about 30 minutes. As a result, a wax dispersion was obtained. After completing the dispersion, the particle size of the wax was measured by using a Multisizer 2000 (Malvern Instruments, Ltd.), and D50 (v) was 320 nm.

### Example 1

When the polyester resin dispersion prepared according to Preparation Example 2 was regarded as 100% by weight, 4.5% by weight (based on the polyester resin dispersion) of the cyan pigment dispersion prepared according to Preparation Example 3 was and 5.8% by weight (based on the polyester resin dispersion) of the wax dispersion prepared according to Preparation Example 4 were mixed to obtain a mixed solution. The above-mentioned amounts were based on solid contents. Here, purified water was adjusted to have total solid contents of 13% by weight. The temperature of the reactor was increased to 25° C. and the contents included in the reactor were mixed by stirring at 120 rpm. 5.18% by weight of NaCl aqueous solution (4.5 wt %) (based on toner solid content) as agglomerating agent was added to the reactor and homogenizing process using a homogenizer T-50 (IKA Co.) while stirring at 140 rpm was performed. Next, the temperature of the reactor was increased to 51.2° C., and aggregation continued until D50 (v) was 6.9 μm. Then, 3.63% by weight (sodium hydroxide solid content based on the toner solid content) of a 1N sodium hydroxide aqueous solution was introduced into the reactor to stop the growth of the particles and the stirring rate was decreased to 80 rpm. Then, the temperature of the reactor was increased to 97.2° C. to fuse the toner particles. The fusing was performed for 3.5 hours until circularity became 0.970. Then, temperature of the reactor was lowered down to 40° C., and the toner was separated by using a filtration device (name of the device: filter press) and the separated toner was then washed with 1N aqueous nitric acid, re-washed with distilled water, to entirely remove the surfactants or the like. The toner particles obtained after the washing process was dried using an air-flow type dryer. Here, an outlet temperature of the air-flow type dryer was 51° C., and a closing rate of materials was 9 kg/hr.

### Example 2

Toner particles were obtained in the same manner as in Example 1, except that the aggregation temperature was 51.5° C., and the fusing was performed for 4 hours.

### Example 3

Toner particles were obtained in the same manner as in Example 1, except that the aggregation temperature was 51.0° C.

### Example 4

Toner particles were obtained in the same manner as in Example 1, except that the time required for the fusing was 4 hours, the circularity was 0.971, the material closing rate of the air-flow type dryer was 20 kg/hr in the drying process, and the outlet temperature of the reactor body was 55° C.

### Example 5

Toner particles were obtained in the same manner as in Example 1, except that the time required for the fusing was 5.5 hours, and the material closing rate of the air-flow type dryer was 6.5 kg/hr in the drying process.

### Example 6

Toner particles were obtained in the same manner as in Example 1, except that the time required for the fusing was 6.5 hours.

### Example 7

Toner particles were obtained in the same manner as in Example 1, except that the time required for the fusing was 3 hours.

### Comparative Example 1

### SMF<8.5

Toner particles were obtained in the same manner as in Example 1, except that the aggregation temperature was 52.9° C. during the preparation, the fusing was performed for about 7 hours, an air-flow type dryer was used, and the material closing rate of the air-flow type dryer was 30 kg/hr in the drying process.

### Comparative Example 2

### SMF>10.5

Toner particles were obtained in the same manner as in Example 1, except that the aggregation temperature was 50.1° C. during the preparation, the time required for the fusing was 2 hours, an air-flow type dryer was used, and the material closing rate of the air-flow type dryer was 4.5 kg/hr in the drying process.

Experimental conditions according to Examples 1 to 7 and Comparative Examples 1 and 2 are shown in Table 1.

TABLE 1

| | | | | | | | | Comparative | Comparative |
|---|---|---|---|---|---|---|---|---|---|
| | Example 1 | Example 2 | Example 3 | Example 4 | Example 5 | Example 6 | Example 7 | Example 1 | Example 2 |
| Aggregation | 51.2 | 51.5 | 51.0 | 51.8 | 51.8 | 52.8 | 52.8 | 52.9 | 50.1 |
| temperature | | | | | | | | | |
| (° C.) | | | | | | | | | |
| Freezing | 6.2 | 6.2 | 6.2 | 7.0 | 7.0 | 6.2 | 6.2 | 6.2 | 6.2 |
| pH | | | | | | | | | |
| Fusing | 97.2 | 97.9 | 97.5 | 97.3 | 97.3 | 97.5 | 98.5 | 97.9 | 98.0 |
| temperature | | | | | | | | | |
| (° C.) | | | | | | | | | |
| Time | 3.5 | 4.0 | 3.5 | 4.0 | 5.5 | 6.5 | 3.0 | 7.0 | 2.0 |
| required for | | | | | | | | | |
| fusing (hrs) | | | | | | | | | |
| Closing | 9 | 9 | 9 | 20 | 6.5 | 9 | 9 | 30 | 4.5 |
| speed of air- | | | | | | | | | |
| flow type | | | | | | | | | |
| dryer (kg/hr) | | | | | | | | | |
| Outlet | 51 | 51 | 51 | 55 | 51 | 51 | 51 | 60 | 51 |
| temperature | | | | | | | | | |
| of air-flow | | | | | | | | | |
| type dryer | | | | | | | | | |
| (° C.) | | | | | | | | | |

Evaluation of the toner particles prepared according to Examples and Comparative Examples was performed as follows:

Cohesiveness

After external addition, cohesiveness of the toner was measured by using a powder tester (Hosokawa micron Group). 3 meshes were used, and each respective mesh had an opening size of 53 μm, 45 μm, and 38 μm. In the first measurement, 2 g of the toner was weighed, then put on the 53 μm mesh, and measured for 40 seconds at a vibration of dial 1. After completion of 40 seconds of vibration, the weight of the three meshes was measured to measure the amount of residual toner on the mesh. After the measurement, cohesiveness was calculated using the following equation: Cohesiveness (%)={(weight of the remaining powder on the upper sieve)/2}×100×(1/5)+{(weight of the remaining powder on the middle sieve)/2}×100×(3/5)+{(weight of the remaining powder on the bottom sieve)/2}×100×1/5)

Environmental Resistance (i.e., Measurement of Environmental Difference)

A triboelectrification quantity (TV_{HH}) at high-temperature and humidity and a triboelectrification quantity (TV_{LL}) at low-temperature and humidity were measured and determined as a value of TV_{HH}/TV_{LL}. The higher the value of TV_{HH}/TV_{LL}, the less environmental difference is shown.

High-temperature and humidity conditions: 40° C./85%
Low-temperature and humidity conditions: 15° C./15%
The triboelectrification quantity was measured by mixing a carrier and toner at a ratio of 93:7 using a Epping Q/M meter (Germany) and then performing pretreatment for about 2 hours using a turblar mixer. The pretreated sample was measured after about 8 hours of exposure under high-temperature and humidity and low-temperature and humidity. The measurement was performed three times, and the average value thereof was recorded.

Chargeability

After external addition, chargeability of the toner was measured by using a q/m meter (Epping Co., Germany). For pretreatment of a sample to be measured, a carrier and toner were weighed at a ratio of 97%:3%, and mixed in a 10 ml container for about 90 minutes using a turblar mixer (WAB Co., Switzerland). A rate of the turblar mixer was maintained at about 96 rpm.

After the mixing, 1 g of the sample was added to a measurement cell of the q/m meter, and measured for about 120 seconds. This process was repeated twice more, measured three times in total, and the average of the data was recorded.

Results of the charge quantity data obtained from the Examples and Comparative Examples are shown in Table 2.

TABLE 2

| | | | | | | | | Comparative | Comparative |
|---|---|---|---|---|---|---|---|---|---|
| | Example 1 | Example 2 | Example 3 | Example 4 | Example 5 | Example 6 | Example 7 | Example 1 | Example 2 |
| Average | 6.9 | 7.2 | 6.5 | 6.8 | 6.8 | 7.0 | 6.9 | 11.5 | 4.7 |
| particle size | | | | | | | | | |
| (μm) | | | | | | | | | |
| RD | 1.099 | 1.101 | 1.077 | 1.112 | 1.079 | 1.102 | 1.098 | 1.316 | 1.021 |
| (g/cm³) | | | | | | | | | |
| B | 1.431 | 1.449 | 1.48 | 2.187 | 1.197 | 1.481 | 1.459 | 3.129 | 0.591 |
| (m²/g) | | | | | | | | | |
| Circularity | 0.969 | 0.971 | 0.970 | 0.971 | 0.973 | 0.974 | 0.968 | 0.975 | 0.962 |
| SMF | 9.582 | 9.519 | 9.653 | 9.411 | 9.684 | 9.545 | 9.574 | 8.495 | 10.501 |
| Data | | | | | | | | | |
| Fluidity | 9.1 | 9.0 | 8.7 | 8.0 | 12.7 | 9.0 | 8.9 | 6.5 | 15.1 |
| (%) | | | | | | | | | |
| Charge | −60.77 | −59.82 | −60.26 | −57.26 | −53.36 | −58.72 | −59.76 | −33.52 | −44.98 |
| quantity | | | | | | | | | |
| (H/H, −60.77 uC/g) | | | | | | | | | |
| Charge | −72.71 | −74.69 | −73.35 | −80.65 | −73.10 | −71.90 | −72.67 | −65.72 | −83.29 |
| quantity | | | | | | | | | |
| (L/L, uC/g) | | | | | | | | | |
| Environmental | 0.84 | 0.81 | 0.82 | 0.71 | 0.73 | 0.82 | 0.82 | 0.51 | 0.54 |
| resistance | | | | | | | | | |
| (Environmental | | | | | | | | | |
| difference) | | | | | | | | | |

As shown in Table 2, the toner particles prepared according to Examples 1 to 7 have excellent environmental resistance, fluidity, and chargeability.

1. Toner particles for developing an electrostatic image, the toner particles each comprising a binder resin, a releasing agent, and a colorant, wherein the toner particles satisfy Formula (1) below:
8.5≦SMF≦10.5 (1)
wherein, a surface morphology factor (SMF) is obtained by Formula (2) below:
SMF=−log(4/3×π×D³×RD×B×C) [m²/ea] (2)
wherein,
D represents an average radius (μm) of the toner particles,
RD represents a net density (g/cm³) of the toner particles,
B represents a specific surface area (m²/g) based on Brunauer-Emmett-Teller (BET) theory, and
C represents circularity.

2. The toner particles of claim 1, wherein the toner particles have a net density in a range from about 1.021 to about 1.316 g/cm³.

3. The toner particles of claim 1, wherein the toner particles have circularity in a range from about 0.962 to about 0.975.

4. The toner particles of claim 1, wherein the toner particles have a specific surface area based on the BET theory in a range from about 0.591 to about 3.129 m²/g.

5. The toner particles of claim 1, wherein the toner particles have an average radius in a range from about 2.35 to about 5.75 μm.

6. The toner particles of claim 1, wherein the toner particles have cohesiveness in a range from about 6.50% to about 15.1%.

7. An electrostatic image developer, comprising the toner particles of claim 1.

8. The electrostatic image developer of claim 7, wherein the electrostatic image developer comprises at least one carrier selected from the group consisting of ferrite coated with an insulating material, magnetite coated with an insulating material, and iron powder coated with an insulating material.

9. A method of forming an electrophotographic image, the method comprising:
adhering toner to a photoreceptor surface with an electrostatic latent image thereon to form a toner image; and
transferring the toner image onto a transfer medium,
wherein the toner particles of claim 1 are used as toner.

10. An electrostatic image developer, comprising the toner particles of claim 2.

11. The electrostatic image developer of claim 10, wherein the electrostatic image developer comprises at least one carrier selected from the group consisting of ferrite coated with an insulating material, magnetite coated with an insulating material, and iron powder coated with an insulating material.

12. An electrostatic image developer, comprising the toner particles of claim 3.

13. The electrostatic image developer of claim 12, wherein the electrostatic image developer comprises at least one carrier selected from the group consisting of ferrite coated with an insulating material, magnetite coated with an insulating material, and iron powder coated with an insulating material.

14. An electrostatic image developer, comprising the toner particles of claim 4.

15. The electrostatic image developer of claim 14, wherein the electrostatic image developer comprises at least one carrier selected from the group consisting of ferrite coated with an insulating material, magnetite coated with an insulating material, and iron powder coated with an insulating material.

16. An electrostatic image developer, comprising the toner particles of claim 5.

17. The electrostatic image developer of claim 16, wherein the electrostatic image developer comprises at least one carrier selected from the group consisting of ferrite coated with an insulating material, magnetite coated with an insulating material, and iron powder coated with an insulating material.

18. An electrostatic image developer, comprising the toner particles of claim 6.

19. The electrostatic image developer of claim 18, wherein the electrostatic image developer comprises at least one carrier selected from the group consisting of ferrite coated with an insulating material, magnetite coated with an insulating material, and iron powder coated with an insulating material.

20. A method of forming an electrophotographic image, the method comprising:
adhering toner to a photoreceptor surface with an electrostatic latent image thereon to form a toner image; and
transferring the toner image onto a transfer medium,
wherein the toner particles of claim 2 are used as toner.

21. A method of forming an electrophotographic image, the method comprising:
adhering toner to a photoreceptor surface with an electrostatic latent image thereon to form a toner image; and
transferring the toner image onto a transfer medium,
wherein the toner particles of claim 3 are used as toner.

22. A method of forming an electrophotographic image, the method comprising:
adhering toner to a photoreceptor surface with an electrostatic latent image thereon to form a toner image, and
transferring the toner image onto a transfer medium,
wherein the toner particles of claim 4 are used as toner.

23. A method of forming an electrophotographic image, the method comprising:
adhering toner to a photoreceptor surface with an electrostatic latent image thereon to form a toner image; and
transferring the toner image onto a transfer medium,
wherein the toner particles of claim 5 are used as toner.

24. A method of forming an electrophotographic image, the method comprising:
adhering toner to a photoreceptor surface with an electrostatic latent image thereon to form a toner image; and
transferring the toner image onto a transfer medium,
wherein the toner particles of claim 6 are used as toner.
